(19) United States
(12) Patent Application Publication
(10) Pub. No.: US 2011/0099534 A1
(43) Pub. Date: Apr. 28, 2011

(54) INFORMATION PROCESSING APPARATUS, EXECUTION PROGRAM OPERATION MODIFICATION METHOD, AND RECORDING MEDIUM

(75) Inventor: Ikuo HAKAMATA, Kawasaki (JP)

(73) Assignee: FUJITSU LIMITED, Kawasaki-shi (JP)

(21) Appl. No.: 12/908,331

(22) Filed: Oct. 20, 2010

(30) Foreign Application Priority Data
Oct. 22, 2009 (JP) 2009-243648

(51) Int. Cl. G06F 9/44

(52) U.S. Cl. 717/110

(57) ABSTRACT

A disclosed information processing apparatus capable of modifying an operation of an execution program includes an instruction information receiving unit that receives instruction information from an execution environment; an instruction information interpreting unit that interprets a position and execution contents in a source program from the received instruction information; an instruction information executing unit that refers to debug information including a corresponding relationship between the source program and an execution program main body, specifies a position in the execution program main body, the position corresponding to the interpreted position in the source program, and modifies the specified position in the execution program main body based on the interpreted execution contents; and an execution program main body unit that starts execution of the execution program after processes of the instruction information receiving unit, the instruction information interpreting unit, and the instruction information executing unit have been completed.

### CROSS-REFERENCE TO RELATED APPLICATIONS

This application is based upon and claims the benefit of priority of Japanese Patent Application No. 2009-243648, filed Oct. 22, 2009. The entire contents of which are incorporated herein by reference.

### FIELD

The embodiment discussed herein is related to an information processing apparatus and an execution program operation modification method of modifying operations of an execution program, a recording medium storing an execution program, and a recording medium storing a compiler.

### BACKGROUND

Japanese Laid-Open Patent Applications No. 2003-521766 discloses a system and method for modifying the output of a computer program without source code modification. A computer program reads in two files, an input data file and a recipe text file. The data input file contains name/value pairs to be rendered to an output device and the recipe text file contains the formatting descriptions. The name/value pairs of the data input file need not be arranged according to a required structure. During the execution of the program, the formatting descriptions of the recipe text file are converted into a sequence of executable objects and the name/vale pairs from the data input file are rendered in a format according to these formatting descriptions. A coordinated alteration of the input text file and the recipe text file may result in a modification to the output format.

### SUMMARY

According to an aspect of the present invention, an information processing apparatus capable of modifying an operation of an execution program includes an instruction information receiving unit that receives instruction information from an execution environment; an instruction information interpreting unit that interprets a position and execution contents in a source program from the received instruction information; an instruction information executing unit that refers to debug information including a corresponding relationship between the source program and an execution program main body, specifies a position in the execution program main body, the position corresponding to the interpreted position in the source program, and modifies the specified position in the execution program main body based on the interpreted execution contents; and an execution program main body unit that starts execution of the execution program after processes of the instruction information receiving unit, the instruction information interpreting unit, and the instruction information executing unit have been completed.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are drawings illustrating systems capable of compiling and executing an execution program;

FIG. 2 is a drawing showing an exemplary hardware configuration of a computer;

FIG. 3 is a block diagram illustrating a process of compiling an execution program;

FIG. 4 is a block diagram of an example of a general execution program;

FIG. 5 is a block diagram of an example of an execution program according to an embodiment of the present invention;

FIG. 6 is a block diagram illustrating a process of executing the execution program;

FIG. 7 is a flowchart illustrating a procedure performed before the execution program starts running;

FIG. 8 is a conceptual drawing illustrating the procedure performed before the execution program starts running;

FIG. 9 is a schematic drawing illustrating debug information and relationships between the source program and the execution program;

FIG. 10 is a drawing illustrating examples of data provided by debug information;

FIG. 11 is a drawing illustrating an example of basic rules of the debug information;

FIG. 12 is a drawing illustrating a specific example of the basic rules of the debug information;

FIG. 13 is a drawing illustrating specific examples of tags of the debug information;

FIG. 14 is a drawing illustrating a first example of instruction information;

FIG. 15 is a drawing illustrating a second example of the instruction information;

FIG. 16 is a drawing illustrating a third example of the instruction information;

FIG. 17 is a drawing illustrating a fourth example of the instruction information;

FIG. 18 is a drawing illustrating a fifth example of the instruction information; and

FIG. 19 is a drawing illustrating a sixth example of the instruction information.

### DESCRIPTION OF EMBODIMENT

A compiler refers to conversion software converting a source program (source code) written in a programming language as a design of the software by a human into an object program (object code) in a computer-executable format. The object program (hereinafter referred to as an “execution program”) generated by the compiler operates (runs) based on the descriptions written in the source program. A user, however, may be needed to verify, extend, or modify the operations of the execution program.

In the related art, when the execution program is to be verified, extended, or modified, it may be necessary to modify the source program. Further, it may be necessary to regenerate the execution program using a compiler.

Further, when the execution program is to be verified, extended, or modified, it may be necessary to write the execution program in a memory by using an external tool including a debugger, and then modify the machine language to refer to or modify the data memory contents (see for example, the Non-Patent Document “GDB: The GNU Project Debugger”).

Further, when the execution program is to be verified, extended, or modified, it may be necessary to stop the execution program at the designated position using an OS function to display the data contents, and modify the data contents.

Further, when the execution program is required to be verified, extended, or modified, the execution program may be replaced by another previously designated dynamically writable and callable execution program during a linking process which is one of the processes of generating the execution program by the compiler.

Further, there is a known method of modifying the output format of a computer program without modifying the source of the program (see, for example Japanese Laid-open Patent Publication No. 2003-521766).

In one example, when the execution program is to be verified, extended, or modified, as described above, it may become necessary to modify the source program and regenerate the execution program, use the external tool such as the debugger, modify the execution program using an OS function, or replace the execution program with another execution program in the linking process which is one of the generation processes of the execution program. Further, the above method of modifying the output format of a computer program without modifying the source code of the program is literally for modifying the output format and is not for verifying, extending, and modifying the execution program.

As described above, in one example, when the execution program is to be verified, extended, or modified, it may be necessary to modify the source program and regenerate the execution program, use the external tool such as a debugger, modify the execution program using an OS function, or replace the execution program with another execution program in the linking process. Therefore, in one example, it may require labor and cost.

The present invention is made in light of the above environment, and may provide an information processing apparatus, an execution program operation modification method, and a recording medium storing an execution program and a compiler capable of modifying the operations of the execution program without taking cost and labor.

In the following, a preferred embodiment of the present invention is described based on the examples with reference to the accompanying drawings.

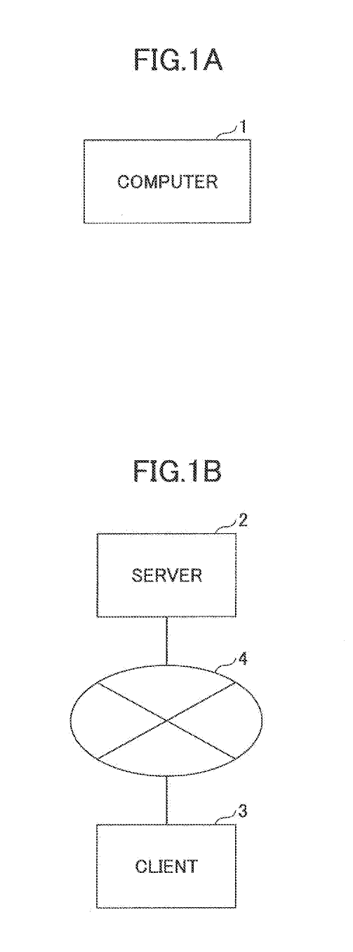

FIGS. 1A and 1B illustrate systems capable of compiling and executing an execution program. A system in FIG. 1A includes a computer 1 which may be a personal computer. A system in FIG. 1B includes a server 2 and a client 3 which are in data communication with each other via a network 4 like the Internet. In the following, it is assumed that a system compiling and executing an execution program includes a configuration of FIG. 1A. When the configuration of FIG. 1B is to be used, the processes to have been performed by the computer 1 are instead collaboratively performed by the server 2 and the client 3 with mutual communications.

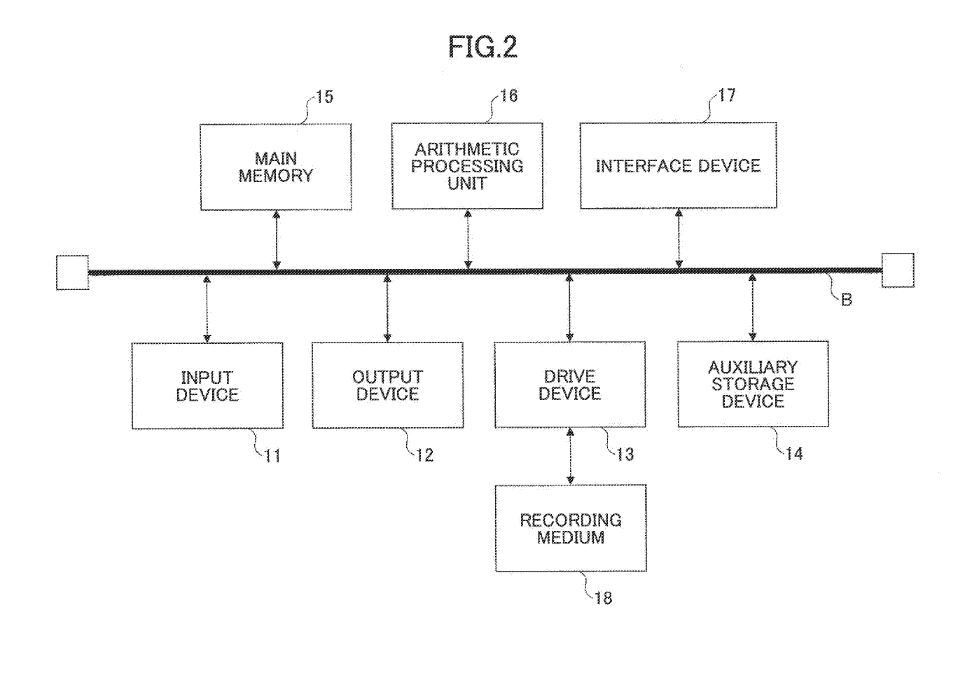

FIG. 2 illustrates an exemplary hardware configuration of the computer 1. The computer 1 is one example of an information processing apparatus and can act as an execution program operation modification apparatus capable of modifying an operation of an execution program. As illustrated in FIG. 2, the computer 1 includes an input device 11, an output device 12, a drive device 13, an auxiliary storage device 14, a main memory 15, an arithmetic processing unit 16, and an interface device 17, which are connected to each other via a bus B. The input device 11, the output device 12, the drive device 13, the auxiliary storage device 14, the main memory 15, the arithmetic processing unit 16, and the interface device 17 in FIG. 2 are not necessarily accommodated within a single chassis. For example, those elements may be separately placed in plural chassis.

The input device 11 may include a keyboard, a mouse or the like. Various signals are input in the computer via the input device 11. The output device 12 may include a display device or the like. The display device 12 may display various windows and data. The interface device 17 may include a modem, a LAN card or the like, and is used to connect to a network.

In this embodiment, a compiler and an execution program are at least a part of various programs controlling the computer 1. The compiler and the execution program (hereinafter may be collectively referred to as a “program”) may be provided by, for example, the distribution of a recording medium 18 or by being downloaded from the network. Further, the execution program may be provided in a form of a source program.

The recording medium 18 for storing the program may include various types of recording media such as recording media electrically or magnetically recording data such as a CD-ROM, a flexible disk, a magnetic optical disk and recording media electrically recording data such as semiconductor memories.

Further, when the recording medium 18 storing the program is placed in the drive device 13, the program is installed from the recording medium 18 in the auxiliary storage device 14 via the drive device 13. When downloaded from a network, the program is installed in the auxiliary storage device 14 via the interface device 17.

The auxiliary storage device 14 stores not only the installed programs but also necessary files, data and the like. To boot up a program, the main memory 15 reads the program from the auxiliary storage device 14 and stores the program. Then, the arithmetic processing unit 16 performs various processes described below based on the program stored in the main memory 15.

In the following, a compiling process to generate an execution program and an executing (running) process of the execution program in this embodiment are separately described.

### Compiling Process to Generate Execution Program

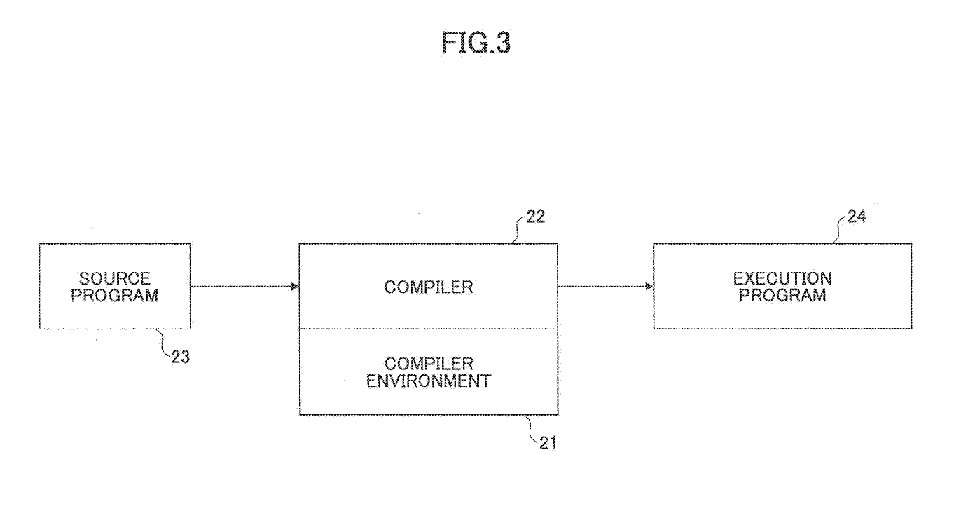

FIG. 3 is a block diagram illustrating a compiling process to generate an execution program. As illustrated in FIG. 3, a compiler environment 21 is provided to operate a compiler 22. Further, the compiler environment 21 is determined based on the OS, a type of hardware, a hardware configuration and the like. Namely, the compiler 22 operates in the compiler environment 21.

The compiler 22 has a translation function. By using the translation function, the compiler 22 generates debug information described below and an execution program main body from a source program 23 and generates an execution program 24 including the debug information and the execution program main body. Namely, the debug information and the execution program main body are objects generated by the compiler 22.

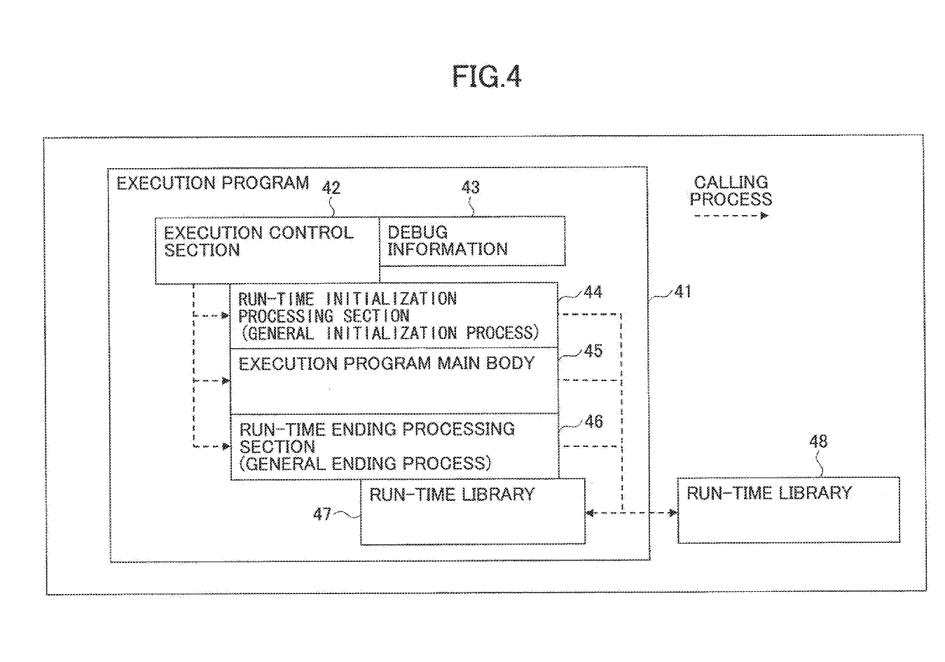

Herein, to facilitate the understanding of this embodiment, a configuration of a general execution program and a configuration of an execution program in this embodiment are separately described to be compared. FIG. 4 is a block diagram illustrating an exemplary configuration of a general execution program 41.

As illustrated in FIG. 4, the execution program 41 may include an execution control section 42, debug information 43, a run-time initialization processing section 44, an execution program main body 45, a run-time ending processing section 46, and run-time libraries 47 and 48. Further, the execution program 41 may not include the debug information 43 and the run-time libraries 47 and 48. The run-time library may be included as a part of the execution program 41 as indicated as the run-time library 47 and may exist outside the execution program 41 as indicated as the run-time library 48 in FIG. 4. The run-time library 48 may includes a part provided by the OS.

The execution control section 42 calls and processes the run-time initialization processing section 44, the execution program main body 45, and the run-time ending processing section 46. Further, each of the run-time initialization processing section 44, the execution program main body 45, and the run-time ending processing section 46 calls and processes the run-time libraries 47 and 48. The run-time initialization processing section 44 performs a general initialization process. The run-time ending processing section 46 performs a general ending process.

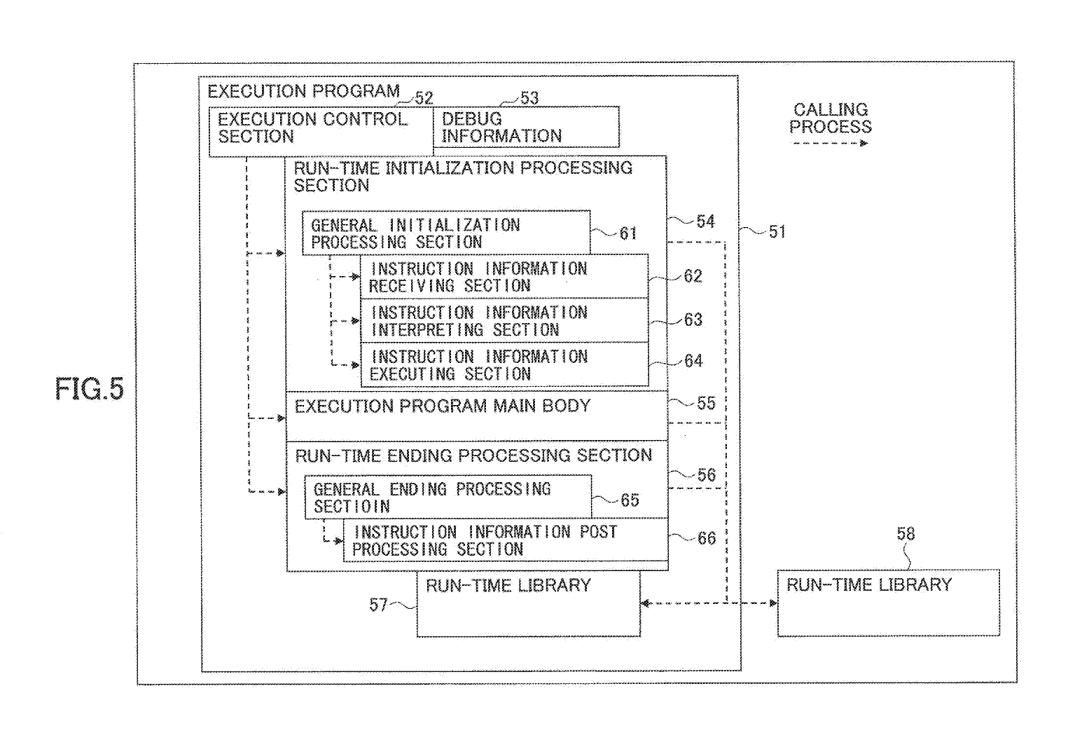

On the other hand, FIG. 5 is a block diagram illustrating an exemplary configuration of an execution program according to this embodiment of the present invention. As illustrated in FIG. 5, an execution program 51 includes an execution control section 52, debug information 53, a run-time initialization processing section 54, an execution program main body 55, a run-time ending processing section 56, and run-time libraries 57 and 58.

The run-time initialization processing section 54 includes a general initialization processing section 61, an instruction information receiving section 62, an instruction information interpreting section 63, and an instruction information executing section 64. The run-time ending processing section 56 includes a general ending processing section 65 and an instruction information post processing section 66. Further, there may be a case where the run-time libraries 57 and 58 do not exist. The run-time library may be included as a part of the execution program 51 indicated as the run-time library 57 and may exist outside the execution program 51 indicated as the run-time library 58 in FIG. 5. The run-time library 58 may include a part provided by the OS.

The execution control section 52 calls and processes the run-time initialization processing section 54, the execution program main body 55, and the run-time ending processing section 56. Further, each of the run-time initialization processing section 54, the execution program main body 55, and the run-time ending processing section 56 calls and processes the run-time libraries 57 and 58.

The run-time initialization processing section 54 calls and processes the general initialization processing section 61, the instruction information receiving section 62, the instruction information interpreting section 63, and the instruction information executing section 64. The general ending processing section 65 of the run-time ending processing section 56 calls and processes the instruction information post processing section 66. Further, there may be a case where the instruction information post processing section 66 does not exist.

The execution program main body 55 includes a machine language and memory allocation derived from the source program 23. The debug information 53 includes association information between the execution program main body 55 including the machine language and memory allocation derived from the source program 23 and a configuration element of the source program 23. Details of the debug information 53 are described below.

### Execution Process of Execution Program

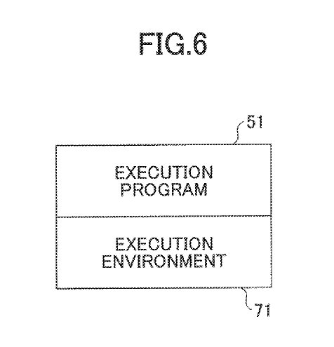

FIG. 6 is a block diagram illustrating a procedure performed before running the execution program 51. As illustrated in FIG. 6, an execution environment 71 is provided to operate (run) the execution program 51. Further, the execution environment 71 is determined based on the OS, the type of hardware, the hardware configuration and the like. Namely, the execution program 51 runs in the execution environment 71.

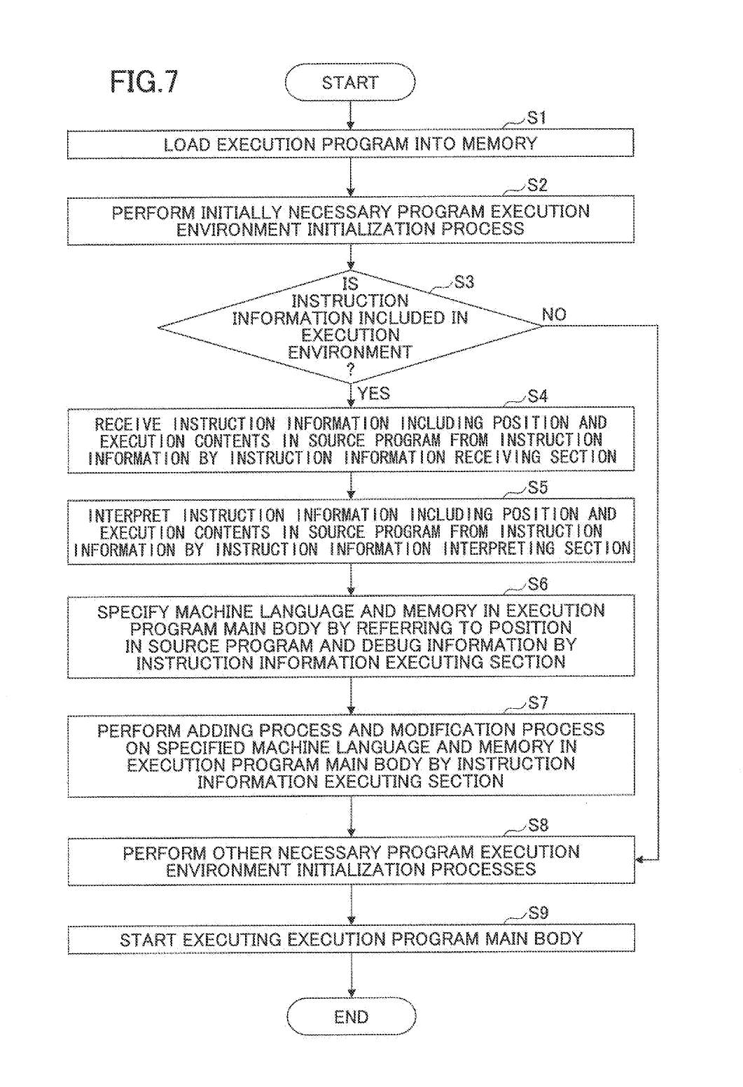

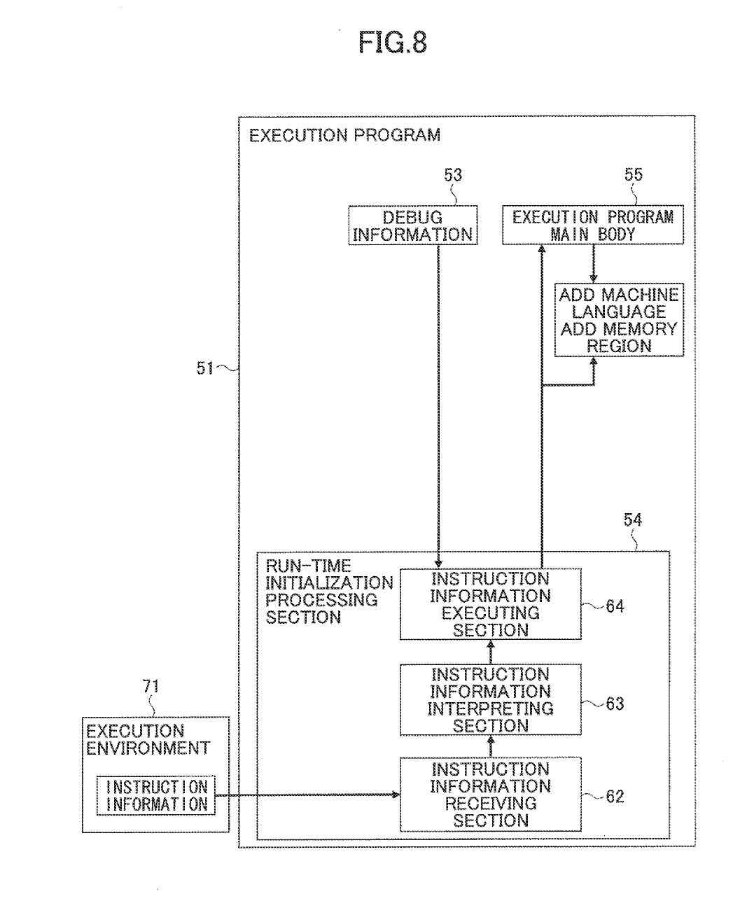

FIG. 7 is a flowchart illustrating a procedure performed before running the execution program 51. Further, FIG. 8 schematically illustrates the procedure before the execution program 51 runs. In FIG. 8, however, some parts unnecessary for the description of the procedure are omitted.

In step S1, the execution program 51 is written in (loaded) to the memory (main memory 15 of the computer 1).

In step S2, the run-time initialization processing section 54 called by the execution control section 52 performs an initially necessary program execution environment initialization process. Specifically, this initially necessary program execution environment initialization process is performed by the general initialization processing section 61.

In step S3, the general initialization processing section 61 determines whether the execution environment 71 includes instruction information. In this case, for example, the general initialization processing section 61 may determine whether the instruction information is included based on a result of querying the OS whether a designated environment variable exists.

Herein, the “instruction information” refers to information that specifies the execution program 51 and designates an operation having not been designated in the source program 23 by designating a constituent element of the source program 23 as a target. For example, the instruction information designates a position and execution contents (contents of the operation) in the source program 23.

When the execution environment 71 includes instruction information (YES in step S3), the process goes to step S4. In step S4, the instruction information receiving section 62 called by the general initialization processing section 61 receives the instruction information from the execution environment 71, the instruction information including a position and execution contents in the source program 23.

Next, in step S5, the instruction information interpreting section 63 called by the general initialization processing section 61 interprets (extracts) the position and the execution contents in the source program 23 from the instruction information.

In step S6, the instruction information executing section 64 called by the general initialization processing section 61 refers to the contents of the instruction information having been interpreted in step S5 and the debug information 53. Further, the instruction information executing section 64 specifies specific machine language and memory position included in the execution program main body 55. By referring to the debug information 53, the instruction information executing section 64 obtains corresponding information between the source program 23 and the execution program main body 55.

In step S7, the instruction information executing section 64 called by the general initialization processing section 61 performs an addition process or modification process on the contents of the machine language and the memory position of the execution program main body 55 in accordance with the execution contents of the instruction information.

In step S8, the general initialization processing section 61 performs the rest of the necessary program execution environment initialization processes. On the other hand, in step S3, when determining that the execution environment 71 does not include the instruction information (NO in step S3), the process goes to step S8 to perform the rest of the necessary program execution environment initialization processes.

In step S9, the execution program main body 55 called by the execution control section 52 starts execution (running).

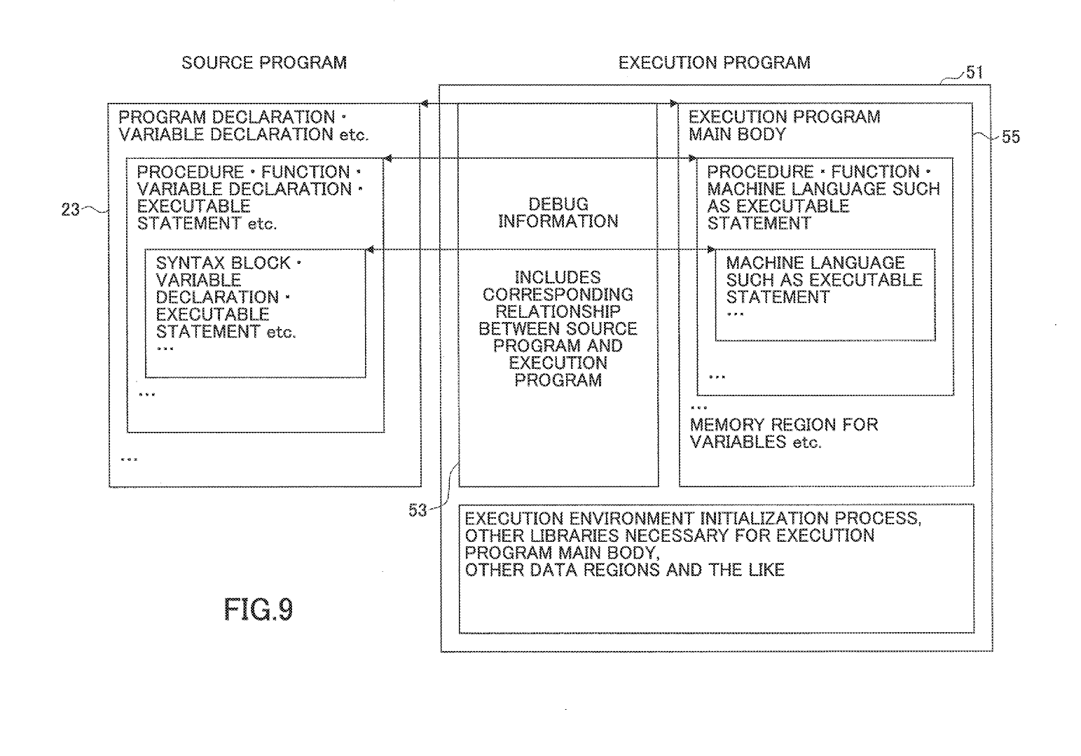

The debug information 53 to be used in step S6 is described. FIG. 9 schematically illustrates an example of the debug information 53 and relationships between the source program 23 and the execution program 51.

As schematically illustrated in FIG. 9, the debug information 53 includes the corresponding relationship between the source program 23 and the execution program main body 55. Specifically, the debug information 53 includes the corresponding relationship between “syntax block•variable declaration•executable statement and the like” in the source program 23 and “machine language such as executable statement” in the execution program main body 55. Further, the debug information 53 includes the corresponding relationship between “procedure•function•variable declaration •executable statement and the like” in the source program 23 and “procedure•function •machine language such as executable statement” in the execution program main body 55. Further, the debug information 53 includes the corresponding relationship between “program declaration•variable declaration and the like” in the source program 23 and the execution program main body 55.

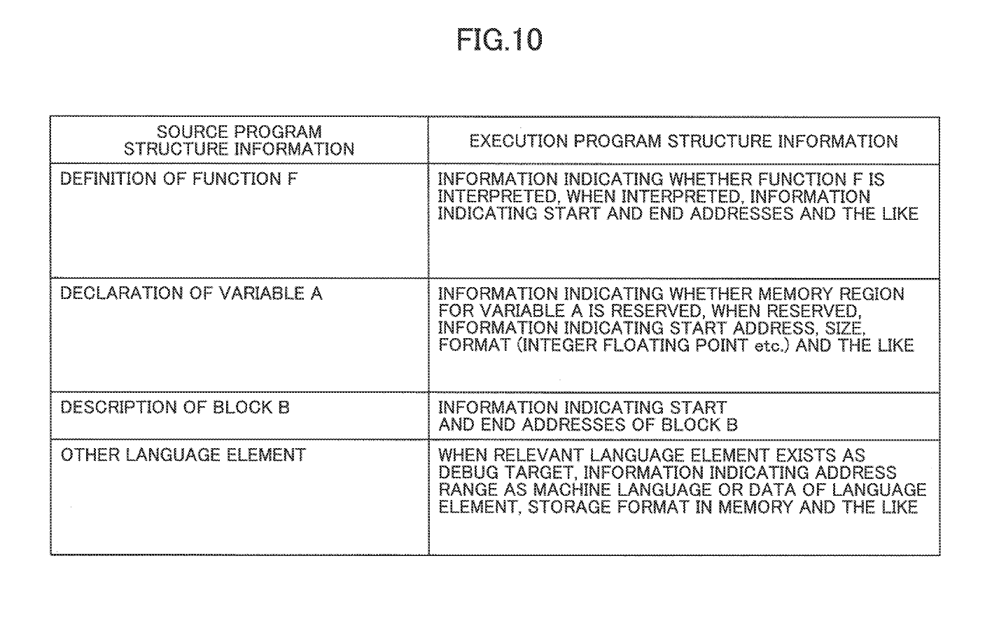

FIG. 10 illustrates an example of data provided by the debug information 53. In FIG. 10, as the structure information of the source program 23, “definition of function F”, “declaration of variable A”, “description of block B”, and “other language element” are provided.

In a case where the structure information of the source program 23 is the “definition of function F”, the debug information 53 includes information indicating whether the function F has been interpreted as a machine language command group. When determining that the function F has been interpreted, the debug information 53 further includes the start address and the end address of the function F as the structure information of the execution program 51.

In a case where the structure information of the source program 23 is the “declaration of variable A”, the debug information 53 includes information indicating whether a memory area for the variable A is reserved. When determining that the memory area for the variable A is reserved, the debug information 53 further includes the start address, the size, and the format (i.e., integer, floating point or the like) of the variable A as the structure information of the execution program 51.

In a case where the structure information of the source program 23 is the “description of block B”, the debug information 53 includes information indicating “the start address and the end address of the block B” as the structure information of the execution program 51.

In a case where the structure information of the source program 23 is the “other language element”, the debug information 53 includes information indicating “the address range, storing format in the memory, value and the like of the machine language or data of a language element when the language element exists as a debug target” as the structure information of the execution program 51.

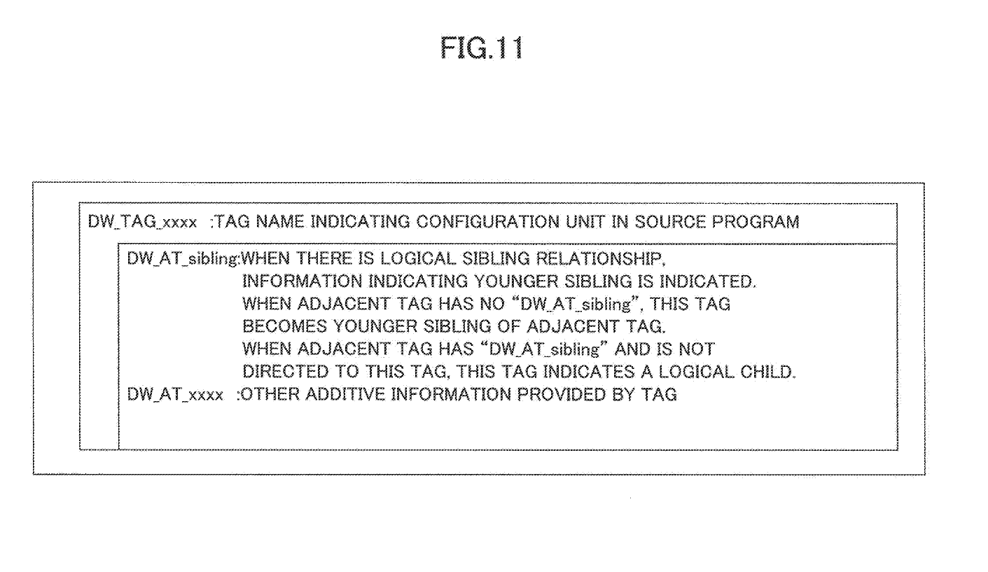

FIG. 11 illustrates an example of basic rules of the debug information 53. In FIG. 11, the debug information is expressed as a set of tags representing element units of the source program 23. Based on the placement of the tags and information included in the tags, a logical relationship in the source program 23 is expressed as illustrated in FIG. 11.

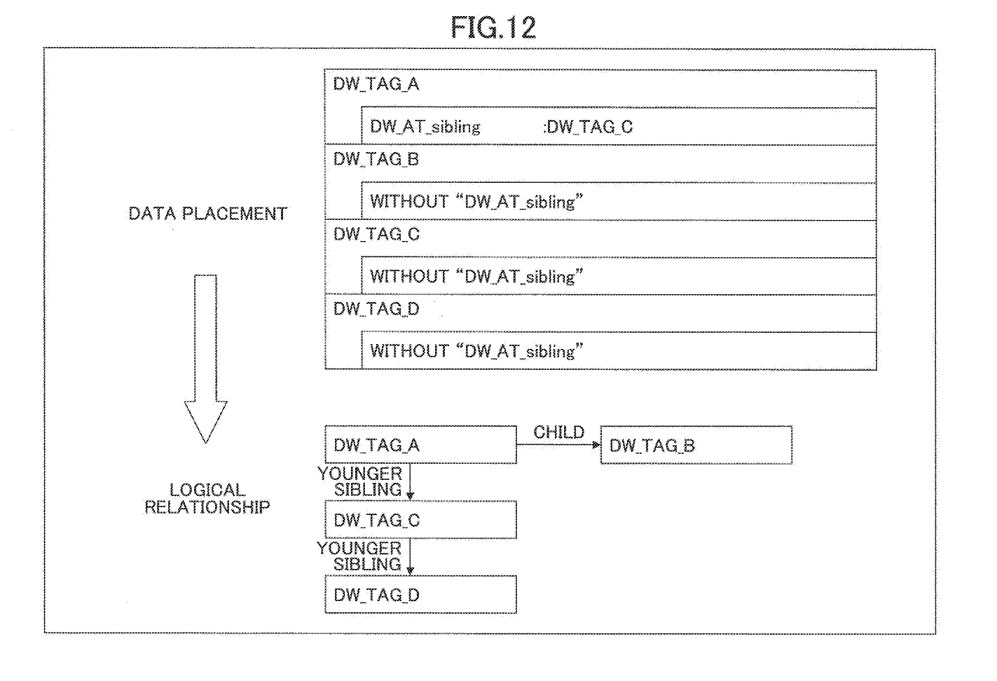

FIG. 12 illustrates a specific example of the basic rules of the debug information. This example of FIG. 12 illustrates correspondence between data placement of the tags and a logical relationship based on the basic rules of the debug information 53. For example, in FIG. 12, the tags A, B, C, D are placed in this order. Further, the tag A includes information “AW_AT_sibling” indicating the tag C. Therefore, a logical relationship as illustrated in the lower part of FIG. 12 may be obtained.

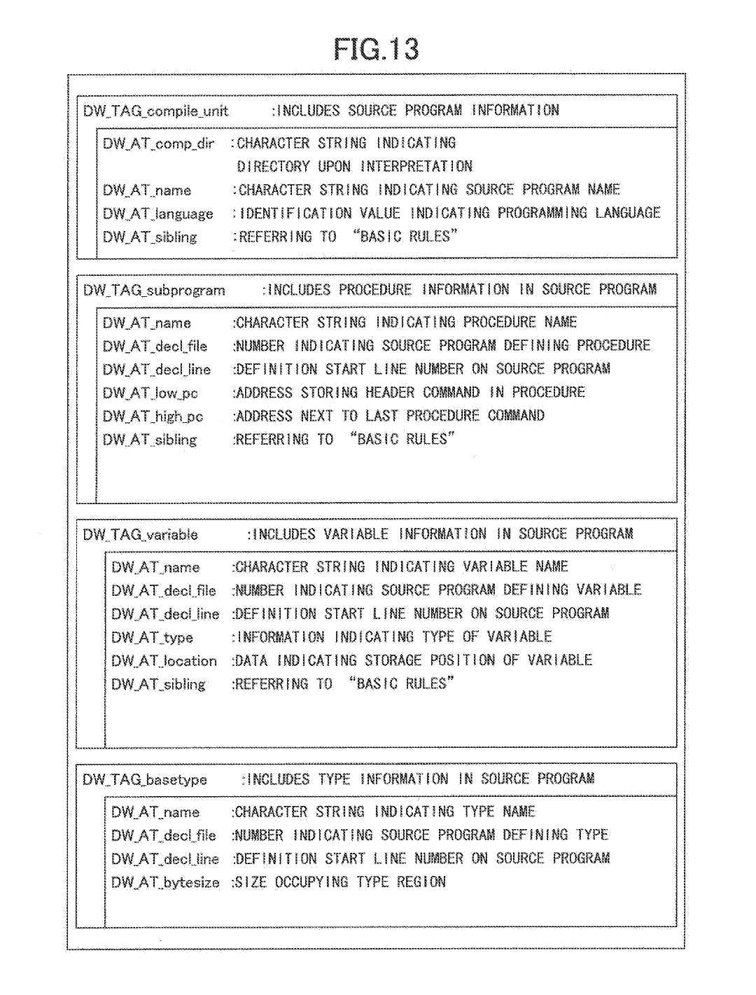

FIG. 13 illustrates specific examples of tags of the debug information. In FIG. 13, the specific examples of the tags are a tag including the information of the source program 23, a tag including the procedure information included in the source program 23, a tag including the variable information included in the source program 23, and a tag including the type information included in the source program 23.

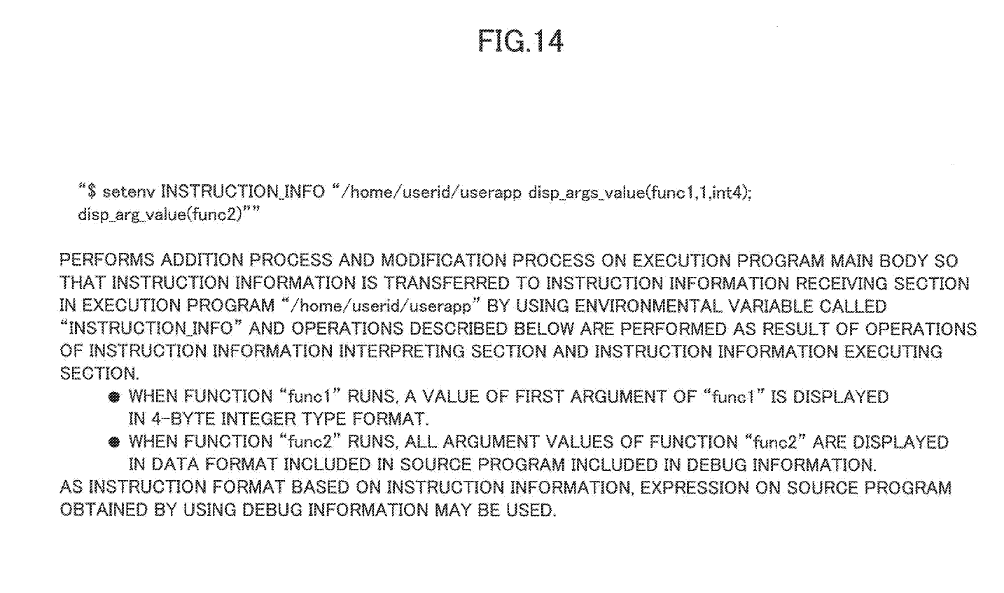

In the following, examples are described of the method of providing the instruction information. FIG. 14 illustrates a first example of the method of providing the instruction information. FIG. 14 assumes that “$ setenv INSTRUCTION_INFO “/home/userid/userapp disp_args_value(func1, 1, int4); disp_arg_value(func2)”” performs an addition process and a modification process on the execution program main body 55 so that the instruction information is transferred to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs in a manner such that a value of the first argument of the function “func1” is to be displayed in a 4-byte integer type format when the function “func1” in the execution program 51 runs. Further, after the addition process and the modification process are performed on the execution program main body 55, the execution program main body 55 runs in a manner such that all argument values of the function “func2” are to be displayed in the data format that is in the source program 23 and that is included in the debug information when the function “func2” in the execution program 51 runs. Further, as an instruction format based on the instruction information, an expression on the source program 23 obtained by using the debug information may be used.

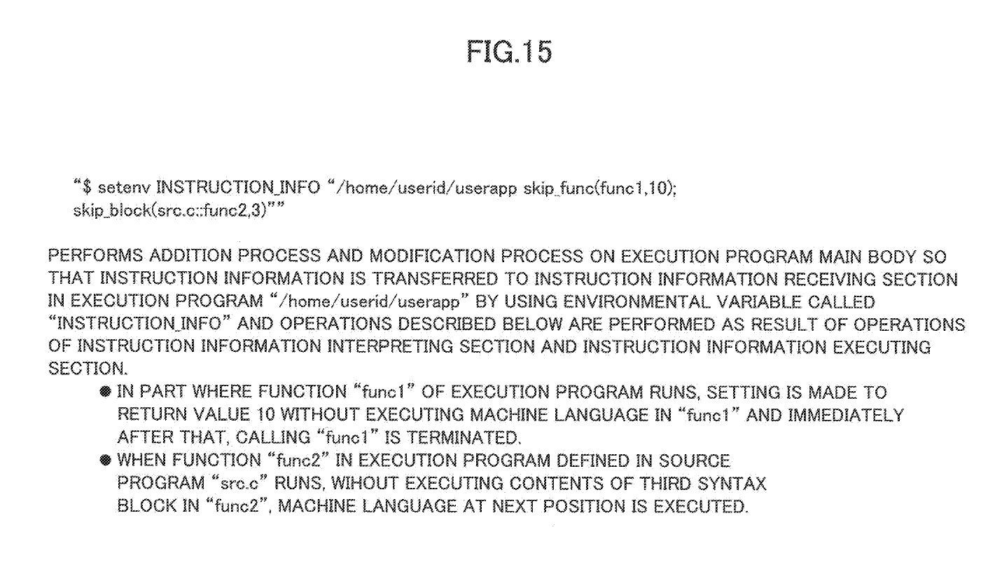

FIG. 15 illustrates a second example of the method of providing the instruction information.

FIG. 15 assumes that “$ setenv INSTRUCTION_INFO “/home/userid/userapp skip_func(func1, 10); skip_block(src.c::func2, 3)”” performs an addition process and a modification process on the execution program main body 55 so that the instruction information is transferred to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs so that, in the part where the function “func1” of the execution program 51 runs, a setting is made to return a value 10 without executing the machine language in the “func1” and immediately after that, calling the “func1” is terminated. Further, after the addition process and the modification process are performed on the execution program main body 55, the execution program main body 55 runs so that when the function “func2” in the execution program 51 defined in the source program “src.c” runs, without executing the contents of the third syntax block in the “func2”, the machine language at the next position is to be executed.

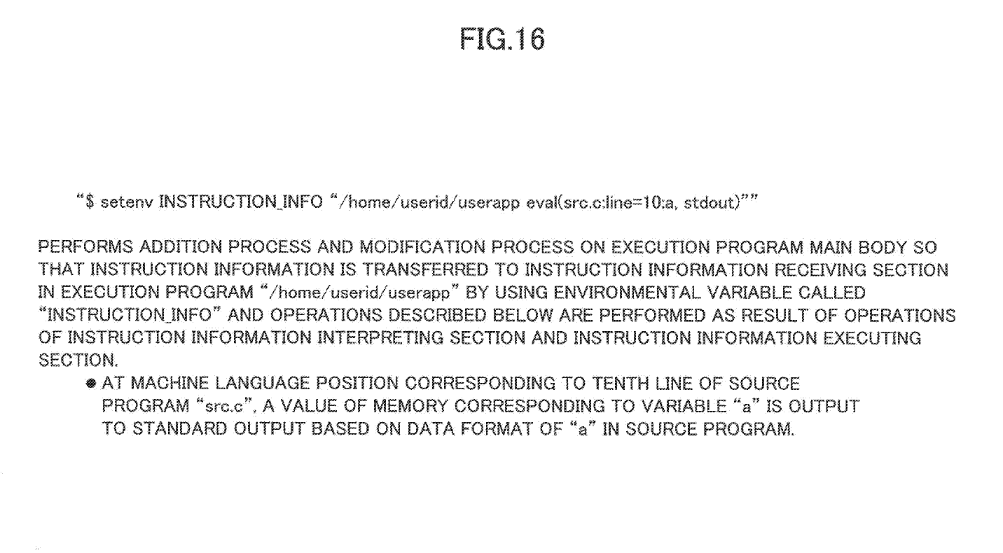

FIG. 16 illustrates a third example of the method of providing the instruction information.

FIG. 16 assumes that “$ setenv INSTRUCTION_INFO “/home/userid/userapp eval(src.c:line=10:a, stdout)”” performs an addition process and a modification process on the execution program main body 55 so that the instruction information is transferred to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs so that a value of a memory corresponding to a variable “a” is output to a standard output at the machine language position corresponding to the tenth line of the source program “src.c” based on the data format of “a” in the source program 23.

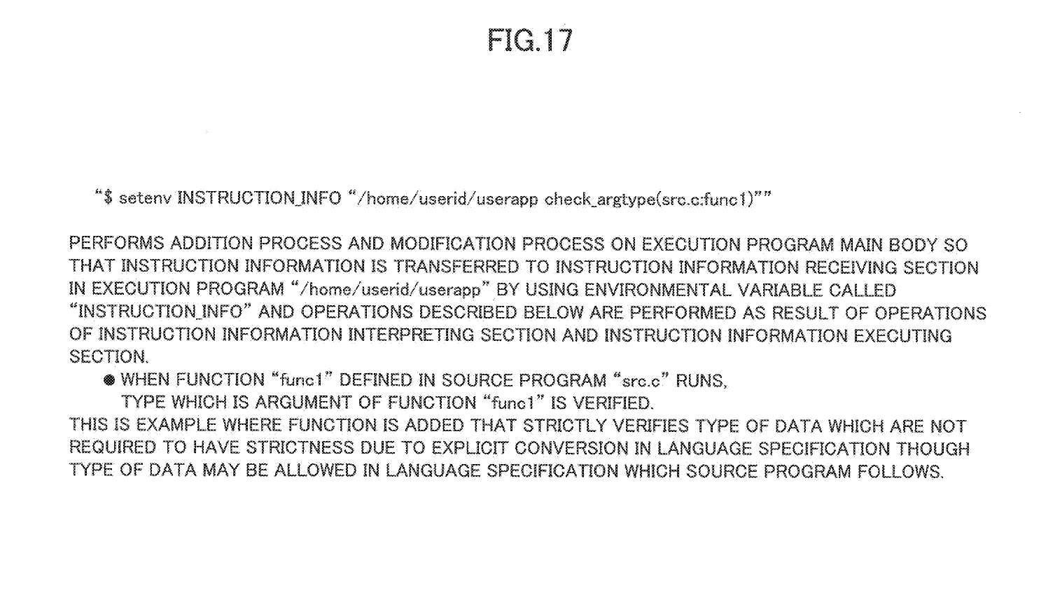

FIG. 17 illustrates a fourth example of the method of providing the instruction information.

FIG. 17 assumes that “$ setenv INSTRUCTION_INFO “/home/userid/userapp check_argtype(src.c:func1)”” performs an addition process and a modification process on the execution program main body 55 so that the instruction information is transferred to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs so that, when the function “func1” defined in the source program “src.c” runs, the type which is the argument of the function “func1” is to be verified. This is an example where a function is added that strictly verifies the type of data which are not required to have strictness due to explicit conversion in a language specification, though the type of the data may be allowed in the language specification which the source program 23 follows.

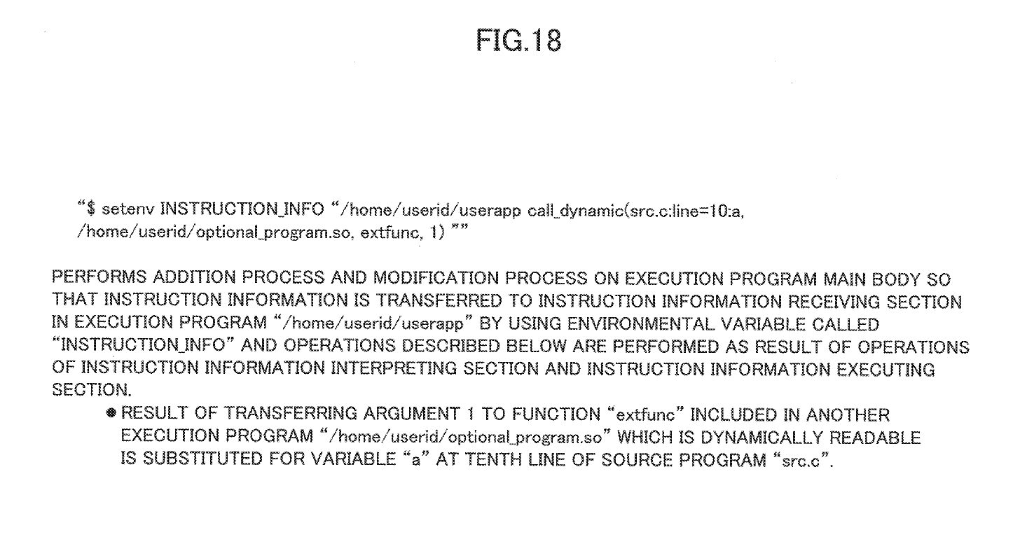

FIG. 18 illustrates a fifth example of the method of providing the instruction information.

FIG. 18 assumes that “$ setenv INSTRUCTION_INFO “/home/userid/userapp call_dynamic (src.c:line=10:a,/home/userid/optional_program.so, extfunc, 1)”” performs an addition process and a modification process on the execution program main body 55 so that the instruction information is transferred to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs so that a result of transferring the argument 1 to the function “extfunc” included in another execution program “/home/userid/optional_program.so” which is dynamically readable is substituted for the variable “a” at the tenth line of the source program “src.c”.

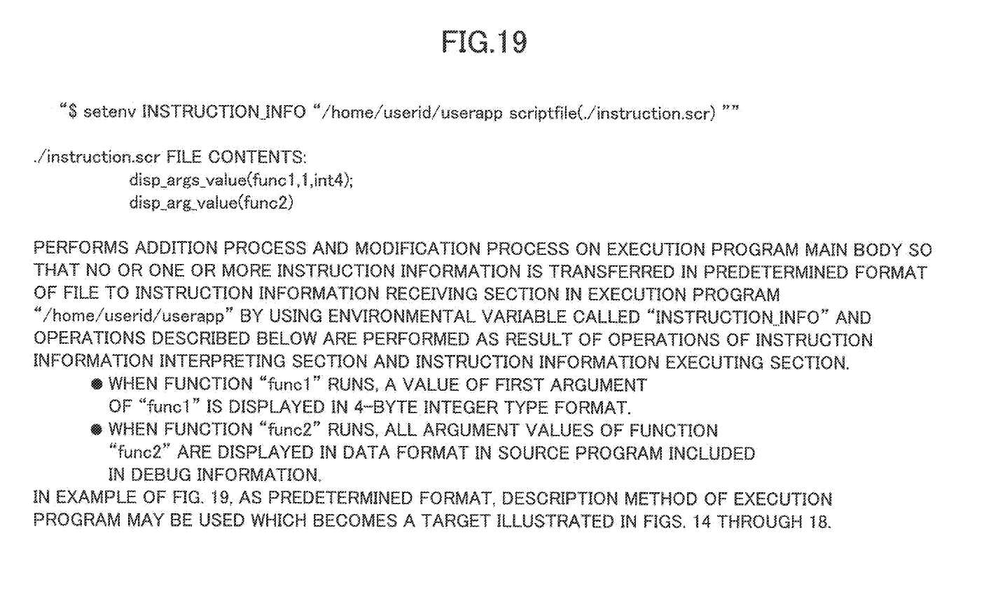

FIG. 19 illustrates a sixth example of the method of providing the instruction information.

FIG. 19 assumes that “$ setenv INSTRUCTION_INFO “/home/userid/userapp scriptfile (./instruction.scr)”

./instruction.src FILE CONTENTS:

disp_args_value(func1, 1, int4);

disp_arg_value(func2)” performs an addition process and a modification process on the execution program main body 55 so that no or one or more instruction information elements are transferred in a predetermined file format to the instruction information receiving section 62 in the execution program “/home/userid/userapp” by using the environmental variable called “INSTRUCTION_INFO” and the operations described below are performed as a result of the operations of the instruction information interpreting section 63 and the instruction information executing section 64.

After the addition process and the modification process are performed on the execution program main body 55, the execution program main body 55 runs so that, when the function “func1” in the execution program 51 runs, a value of the first argument of the function “func1” is to be displayed in the 4-byte integer type format. Further, after the addition process and the modification process are performed on the execution program main body 55, the execution program main body 55 runs so that, when the function “func2” in the execution program 51 runs, all argument values of the function “func2” are to be displayed in the data format that is in the source program 23 and that is included in the debug information.

Further, in the example of FIG. 19, as the predetermined format, a description method of the execution program 51 may be used which becomes a target illustrated in FIGS. 14 through 18.

### SUMMARY OF THE EMBODIMENT

According to this embodiment of the present invention, the operation of the execution program 51 may be modified by adding and modifying an operation which is not designated in an original source program 23 without modifying the source program 23, without regenerating the execution program 51, without using an external tool, without modifying the execution program 51 by using an OS function, and without replacing the execution program 51 arranged to be called in advance during the execution of the execution program 51 by another execution program.

When no instruction information is provided, the execution program 51 having been read in the memory and another execution program to be dynamically called from the call origination in the execution program 51 are operated as designated in the source program 23.

On the other hand, when the instruction information is provided to the execution environment 71, for the execution program 51 having been read into the memory and another execution program to be dynamically called from the call origination in the execution program 51, it may become possible for them to be operated in a manner other than designated in the source program 23.

Further, it may become possible to add calling another execution program that had not been designated to be dynamically called upon being linked. Further, it may become possible to stop calling the other execution program to be dynamically called from the call origination in the execution program 51. Because of these features, it may become possible to remarkably enhance the degree of freedom of adding and modifying the operations of the execution program 51 that would not otherwise be modified after having been generated, without using an external tool.

A range in the memory that can be designated in the instruction information is similar to that of a debugger. Further, in the memory range, a degree of freedom of adding operations and modifying operations applicable to the execution program 51 and another execution program to be dynamically called from the call origination in the execution program 51 designated in advance upon being linked may be enhanced. As a result, in the execution program 51 according to this embodiment of the present invention, it may become possible to record the number of times and the execution order when a part corresponding to the procedure designated in the source program 29, and display, modify, and verify the information indicating parts corresponding to any of the arguments and the variables of a part corresponding to any procedure designated in the source program 23.

Due to the effectiveness even after the generation, the operations of the execution program 51 according to this embodiment of the present invention may be expanded and modified even when the execution program 51 is difficult to be replaced because the execution program 51 is installed in a apparatus having hardware restrictions.

As described above, according to an embodiment of the present invention, it may become possible to modify an execution program without taking cost and labor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that various changes, substitutions, and alterations could be made hereto without departing from the spirit and scope of the invention.

What is claimed is:

1. An information processing apparatus capable of modifying an operation of an execution program, the apparatus comprising:
an instruction information receiving unit that receives instruction information from an execution environment;
an instruction information interpreting unit that interprets a position and execution contents in a source program from the received instruction information;
an instruction information executing unit that refers to debug information including a corresponding relationship between the source program and an execution program main body, specifies a position in the execution program main body, the position corresponding to the interpreted position in the source program, and modifies the specified position in the execution program main body based on the interpreted execution contents; and
an execution program main body unit that starts execution of the execution program after processes of the instruction information receiving unit, the instruction information interpreting unit, and the instruction information executing unit have been completed.

2. The information processing apparatus according to claim 1, wherein
the instruction information executing unit specifies machine language and a memory in the execution program main body, the machine language and the memory corresponding to the interpreted position in the source program, and modifies the specified machine language and the memory in the execution program main body based on the interpreted execution contents or adds machine language and a memory to the specified machine language and the memory in the execution program main body based on the interpreted execution contents.

3. A method of modifying an operation of an execution program executed by a computer, the method comprising:
receiving instruction information from an execution environment;
interpreting a position and execution contents in a source program from the received instruction information;
referring to debug information including a corresponding relationship between the source program and an execution program main body, specifying a position in the execution program main body, the position corresponding to the interpreted position in the source program, and modifying the specified position in the execution program main body based on the interpreted execution contents; and
starting executing the execution program after processes of receiving the instruction information, interpreting the instruction information, referring to the debug information, specifying the position in the execution program main body, and modifying the specified position in the execution program main body have been completed.

4. A non-transitory computer-readable recording medium comprising an execution program encoded and stored in a computer-readable format to cause a computer to execute a process comprising:
receiving instruction information from an execution environment;
interpreting a position and execution contents in a source program from the received instruction information; and
referring to debug information including a corresponding relationship between the source program and an execution program main body, specifying a position in the execution program main body, the position corresponding to the interpreted position in the source program, and modifying the specified position in the execution program main body based on the interpreted execution contents.

5. The non-transitory computer-readable recording medium according to claim 4, wherein
in the referring, the specifying, and the modifying, a machine language and a memory in the execution program main body are specified, the machine language and the memory corresponding to the interpreted position in the source program, and the specified machine language and the memory in the execution program main body are modified based on the interpreted execution contents or a machine language and a memory are added to the specified machine language and the memory in the execution program main body based on the interpreted execution contents.

6. The non-transitory computer-readable recording medium comprising the execution program according to claim 4, wherein
the execution program main body starts after processes of the instruction information receiving unit, the instruction information interpreting unit, and the instruction information executing unit have been completed.

7. The non-transitory computer-readable recording medium comprising a compiler encoded and stored in a computer-readable format to cause a computer to generate the execution program according to claim 4 from the source program.

8. An information processing apparatus capable of modifying an operation of an execution program, the apparatus comprising:
a memory that stores a source program, an execution program main body, and an execution program; and
a processor that realizes
an instruction information receiving unit that receives instruction information from an execution environment;
an instruction information interpreting unit that interprets a position and execution contents in the source program from the received instruction information;
an instruction information executing unit that refers to debug information including a corresponding relationship between the source program and the execution program main body, specifies a position in the execution program main body, the position corresponding to the interpreted position in the source program, and modifies the specified position in the execution program main body based on the interpreted execution contents; and
an execution program main body unit that starts execution of the execution program after processes of the instruction information receiving unit, the instruction information interpreting unit, and the instruction information executing unit have been completed.
